(19) United States
(12) Patent Application Publication
(10) Pub. No.: US 2013/0213013 A1
(43) Pub. Date: Aug. 22, 2013

(54) EXHAUST GAS SENSOR MODULE

(71) Applicant: Cummins IP, Inc., (US)

(72) Inventors: Douglas A. Mitchell, Indianapolis, IN (US); Jim Clerc, Columbus, IN (US); Z. Gerald Liu, Madison, WI (US); Abhishek Manekar, Columbus, IN (US); William L. Simonton, Columbus, IN (US); Tamas Szailer, Seymour, IN (US)

(73) Assignee: CUMMINS IP, INC., Minneapolis, MN (US)

(21) Appl. No.: 13/764,165

(22) Filed: Feb. 11, 2013

Related U.S. Application Data
(63) Continuation-in-part of application No. 13/007,342, filed on Jan. 14, 2011.
(60) Provisional application No. 61/597,574, filed on Feb. 10, 2012.

(51) Int. Cl. F01N 11/00; G01M 15/10

(52) U.S. Cl. CPC F01N 11/00; G01M 15/102
USPC 60/276; 73/23.31

(57) ABSTRACT

Described herein is a sensor module for sensing characteristics of a fluid flowing through a fluid conduit. The sensor module includes a sample probe with at least one sample arm that extends radially inwardly from a sidewall portion of the fluid conduit to a center portion of the fluid conduit, defines a fluid flow channel, and includes a plurality of inlet apertures. The sample probe also includes a sensor well that is located at a radially outer end of the at least one sample arm. The sensor well defines an interior volume that is in fluid communication with the fluid flow channel, an upstream portion closed to an first portion of the fluid conduit upstream of sensor well, and a discharge aperture open to a second portion of the fluid conduit downstream of the sensor well. The sensor module also includes a sensor positioned in the interior volume.

### CROSS-REFERENCE TO RELATED APPLICATION

This application claims the benefit of U.S. Provisional Patent Application No. 61/597,574, filed Feb. 10, 2012, and is a continuation-in-part of U.S. patent application Ser. No. 13/007,342, filed Jan. 14, 2011, which are incorporated herein by reference.

### FIELD

This disclosure relates to sensing characteristics of a fluid, and more particularly to a fluid sensor module for sensing characteristics of a flowing fluid.

### BACKGROUND

Exhaust emissions regulations for internal combustion engines have become more stringent over recent years. For example, the regulated emissions of NOₓ and particulates from diesel-powered internal combustion engines are low enough that, in many cases, the emissions levels cannot be met with improved combustion technologies. Therefore, the use of exhaust after-treatment systems on engines to reduce harmful exhaust emissions is increasing. Typical exhaust after-treatment systems include any of various components configured to reduce the level of harmful exhaust emissions present in the exhaust gas. For example, some exhaust after-treatment systems for diesel-powered internal combustion engines include various components, such as a diesel oxidation catalyst (DOC), a particulate matter filter or diesel particulate filter (DPF), and a selective catalytic reduction (SCR) catalyst. In some exhaust after-treatment systems, exhaust gas first passes through the diesel oxidation catalyst, then passes through the diesel particulate filter, and subsequently passes through the SCR catalyst.

Each of the DOC, DPF, and SCR catalyst components is configured to perform a particular exhaust emissions treatment operation on the exhaust gas passing through or over the components. The DOC, DPF, and SCR catalyst each include a catalyst bed or substrate that facilitates the corresponding exhaust emissions treatment operation. Generally, the catalyst bed of the DOC reduces the amount of carbon monoxide and hydrocarbons present in the exhaust gas via oxidation techniques. The substrate of the DPF filters harmful diesel particulate matter and soot present in the exhaust gas. Finally, the catalyst bed of the SCR catalyst reduces the amount of nitrogen oxides (NOₓ) present in the exhaust gas.

Generally, the catalyst bed of the SCR catalyst is configured to convert NOₓ (NO and NO₂ in some fraction) to N₂ and other compounds. SCR systems utilize a reductant (e.g., diesel exhaust fluid (DEF)) and the SCR catalyst to convert the NOₓ. In most conventional SCR systems, ammonia is used to reduce NOₓ. However, due to the undesirability of handling pure ammonia, most systems utilize an alternate compound such as urea, which vaporizes and decomposes to ammonia before entering the SCR catalyst. When just the proper amount and distribution of ammonia is available at the SCR catalyst under the proper conditions, the ammonia reduces NOₓ in the presence of the SCR catalyst. Currently available SCR systems can produce high NOₓ conversion rates allowing the combustion technologies to focus on power and efficiency. However, currently available SCR systems also suffer from several drawbacks. For example, one known drawback is the inability to effectively provide feedback control of the engine system based on the sensed characteristics of exhaust gas flowing through the SCR system.

Conventional methods for controlling operation of an engine and a reductant doser in an SCR system are based on an open-loop control system. Inputs to the open-loop control system include sensed characteristics of exhaust gas flowing through the system. One or more of the sensed characteristics are compared to a predetermined operating map to obtain an appropriate reductant dosing rate. Typically, the characteristics are sensed at a location upstream of the SCR catalyst of the SCR system. Often, to detect failures or accommodate correction of the map-generated reductant dosing rate, additional characteristics of the exhaust gas sensed at a location downstream of the SCR catalyst can be used. Although a control system employing sensors upstream and downstream of an SCR catalyst provides some benefits, the efficiency and accuracy of the system often suffers with such an arrangement.

Additionally, the design of sensors used in conventional exhaust after-treatment systems for sensing exhaust characteristics often promotes several drawbacks. Typical sensors used in exhaust after-treatment systems are point-measurement devices that sense the concentration of components of the exhaust gas at a single localized point within the exhaust stream. A controller then assigns a component concentration for all the exhaust gas flowing through the system based on the sensed concentration at the localized point. Often, the localized point is at an outer periphery or a center of the exhaust gas stream. In most systems, however, component concentrations within the exhaust gas stream can be poorly spatially distributed. Such poor spatial distribution of components within the exhaust gas can be caused by inadequate mixing of the reductant upstream of the SCR catalyst. Inadequate mixing of reductant upstream of the SCR catalyst can also result in poor distribution of NOₓ downstream of the SCR catalyst. Component concentration calculations for the entire exhaust gas stream based on readings taken from mal-distributed exhaust glow by point-measurement sensors upstream and downstream of the SCR catalyst may be inaccurate. Inaccurate component concentration calculations may lead to measurement errors and potentially negative effects on the efficiency and longevity of an exhaust after-treatment system, particularly an SCR system.

Further, certain probe-type sensors demand a certain exhaust gas flow rate through the probe and past the sensing device for accurate readings. Often, maintaining an adequate exhaust gas flow rate through the probe under a wide range of operating conditions is difficult.

### SUMMARY

The subject matter of the present application has been developed in response to the present state of the art, and in particular, in response to the problems and needs in the fluid sensing art that have not yet been fully solved by currently available sensors and sensing systems. Accordingly, the subject matter of the present application has been developed to provide a fluid sensor module and associated apparatus, systems, and methods for sensing component concentrations in a fluid stream that overcomes at least some shortcomings of the prior art approaches.

According to one embodiment, a sensor module for sensing characteristics of a fluid flowing through a fluid conduit is described herein. The sensor module includes a sample probe that is at least partially positioned within the fluid conduit. The sample probe includes at least one sample arm that extends radially inwardly from a sidewall portion of the fluid conduit to a center portion of the fluid conduit. The at least one sample arm defines a fluid flow channel and includes a plurality of inlet apertures that are open to the fluid flow channel and the fluid conduit. The sample probe also includes a sensor well that is located at a radially outer end of the at least one sample arm. The sensor well defines an interior volume that is in fluid communication with the fluid flow channel. Additionally, the sensor well includes an upstream portion closed to a first portion of the fluid conduit upstream of sensor well and a discharge aperture open to a second portion of the fluid conduit downstream of the sensor well. The sensor module also includes a sensor that is positioned at least partially within the interior volume of the sensor well.

In some implementations of the sensor module, the plurality of inlet apertures captures a sample portion of fluid flowing through the fluid conduit and directs the sample portion of fluid into the interior volume of the sensor well. The sensor is in fluid communication with the sample portion of fluid in the interior volume. The sensor can be inserted through the fluid conduit in certain implementations. According to some implementations, a screen can be positioned within the interior volume of the sensor well, where the screen envelopes the sensor.

According to some implementations of the sensor module, the sensor well further includes a downstream portion configured to create a low pressure zone in the fluid conduit adjacent the discharge aperture. The low pressure zone can draw the sample portion through the plurality of inlet apertures, through the fluid flow channel, through the interior volume of the sensor well, and into the low pressure zone via the discharge aperture. The discharge aperture can have a semi-circular cross-sectional shape.

In certain implementations of the sensor module, the sensor well has a substantially ovular cross-sectional shape. A volume per unit length of the fluid flow channel can be smaller than a volume per unit length of the interior volume of the sensor well in some implementations. In some implementations, the sensor well includes a blunt body. In yet certain implementations, the sensor well is shaped to induce a pressure differential between the plurality of inlet apertures and the discharge aperture.

According to some implementations of the sensor module, the sample probe includes a plurality of sample arms each extending radially inwardly from the sidewall portion of the fluid conduit to the center portion of the fluid conduit. Each of the sample arms defines a fluid flow channel. The fluid flow channels of the plurality of sample arms are fluidly coupled at the center portion of the fluid conduit, and the sensor well is located at the radially outer end of one of the plurality of sample arms.

In certain implementations of the sensor module, the plurality of inlet apertures are spaced closer together near the sidewall portion of the fluid conduit than near the center portion of the fluid conduit. According to one implementation, for each inlet aperture j of the plurality of inlet apertures, the radial distance l away from the sidewall portion of the fluid conduit is equal to

$$\frac{D}{2} ( 1 - \sqrt{\frac{2 n - 2 j + 1}{2 n}} )$$

where D is the diameter of the fluid conduit and n is the number of inlet apertures.

According to another embodiment, an exhaust aftertreatment system includes an exhaust conduit through which an exhaust gas is flowable. The exhaust aftertreatment system also includes at least one sample probe positioned within the exhaust conduit. The at least one sample probe includes at least two sample arms coupled together at a central location and extending radially outwardly away from the central location. Each of the at least two sample arms defines an exhaust flow channel formed therein, and each of the at least two sample arms includes a plurality of inlet apertures extending from an upstream surface of the sample arm to the exhaust flow channel for capturing a sample portion of exhaust gas flowing through the exhaust conduit. The at least one sample probe further includes a sensor well located at a radially outward end of one of the at least two sample arms. The sensor well defines an interior volume that is in exhaust receiving communication with the exhaust flow channels of the at least two sample arms. The sensor well also includes an upstream portion having a blunt rounded surface for diverting exhaust gas flowing through the exhaust conduit around the sensor well, an exhaust discharge aperture open to the exhaust conduit, and a downstream portion for creating a low pressure zone in exhaust gas flowing through the fluid conduit just downstream of the exhaust discharge aperture. The exhaust aftertreatment system further includes a sensor that is positioned at least partially within the interior volume of the sensor well.

In some implementations, the exhaust aftertreatment system further includes a first exhaust treatment device that is positioned within the exhaust conduit upstream of the at least one sample probe, and a second exhaust treatment device that is positioned within the exhaust conduit downstream of the at least one sample probe. The first exhaust treatment device can be a first SCR catalyst, and the second exhaust treatment device can be a second SCR catalyst, in some implementations.

According to certain implementations of the system, the at least one sample probe is a first sample probe and the sensor is a first sensor. The exhaust aftertreatment system may further include a second sample probe positioned within the exhaust conduit downstream of the second exhaust treatment device. The exhaust aftertreatment system includes a second sensor positioned at least partially within the interior volume of the sensor well of the second sample probe.

In some implementations of the system, the at least one sample probe includes an upper arcuate fairing attached to the sensor well located at the radially outward end of the one of the at least two sample arms and a lower arcuate fairing attached to the other of the at least two sample arms. The upper and lower fairings are disconnected from each other, and attached to an interior surface of the exhaust conduit.

According to yet another embodiment, a method for sensing characteristics of a fluid flowing through a fluid conduit includes capturing portions of the fluid at a plurality of radial locations along a cross-section of the fluid conduit. The method also includes directing the captured portions of the fluid into a sensor well located at a radially outer portion of the fluid conduit. Additionally, the method includes passing the captured portions of the fluid across a sensor located in the sensor well. Further, the method includes creating a low pressure zone in the fluid flowing through the fluid conduit at the radially outer portion of the fluid conduit adjacent and downstream of the sensor well, and urging the captured fluid in the sensor well back into the fluid conduit through an aperture in the sensor well via a pressure differential created by the low pressure zone.

According to one embodiment, a sensor module for sensing characteristics of a fluid flowing through a fluid conduit includes a sample probe having one, two, or more sample arms coupled together at a central location, with each of the sample arms extending radially outwardly away from the central location. Each of the sample arms includes a fluid flow channel formed therein and one or more inlet apertures extending from a front surface of the sample arms to the fluid flow channel. The inlet apertures are sized and positioned along the length of the sample arm so as to capture sample portions of fluid from the main fluid flow based on an equal area methodology, wherein a total cross-section of the fluid conduit is divided into multiple sampling sections, with each sampling section having the same area and being sampled by one of the inlet apertures.

The sample probe also includes a sensor well located at the outward end of one of the sample arms. The sensor well surrounds an interior volume which is in fluid communication with the fluid flow channels of the sample arms. The sensor well also includes an outermost portion which opens to the interior surface of the fluid conduit, a front portion having a front surface (which can, in some embodiments, be blunt and rounded) for diverting the main fluid flow around the sensor well, a back portion configured to create at least one low pressure zone in the main fluid flow immediately adjacent the sensor well, and one or more discharge apertures in the back portion that provide fluid communication between the interior volume of the sensor well and the low pressure zone(s). Placing the interior volume of the sensor well in fluid communication with the low pressure zone operates to draw the sample portions of fluid captured by the sample arms through the interior volume of the sensor well and back out to the main fluid flow through the one or more discharge apertures.

The sensor module also includes at least one sensor having a sensing end which has been inserted through the fluid conduit and into the interior volume of the sensor well, and thus into fluid communication with the sample portion flowing through sample probe from the inlet apertures in the sample arms to the discharge aperture in the sensor well.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a schematic block diagram of an internal combustion engine system having an engine, exhaust gas after-treatment system, a sensor module, an optional reductant delivery system, and an engine control unit, in accordance with a representative embodiment;

FIG. 2 is a cross-sectional side view of an SCR system having one or more fluid sensor modules installed therein, in accordance with yet another representative embodiment;

FIG. 3 is a front perspective view of sample probe for a sensor module, in accordance with another representative embodiment;

FIG. 4 is a front view of the sample probe of FIG. 2;

FIG. 5 is a schematic illustration of an equal area sampling methodology;

FIG. 6 is a rear view of the sample probe of FIG. 2;

FIG. 7 is a side view of the sample probe of FIG. 2;

FIG. 8 is a cross-sectional front view of the sample probe of FIG. 2, as viewed from section line A-A of FIG. 6;

FIG. 9 is a cross-sectional front view of a sample probe and sensor installed together within a fluid conduit to form a sensor module, in accordance with another representative embodiment;

FIG. 10 is a schematic, cross-sectional side view of the sensor module of FIG. 8, as viewed from section line B-B;

FIG. 11 is a schematic, cross-sectional top view of the sensor module of FIG. 8, as viewed from section line C-C; and

FIG. 12 is a cross-sectional side view of an SCR system having a bypass version of the fluid sensor module installed therein, in accordance with yet another representative embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

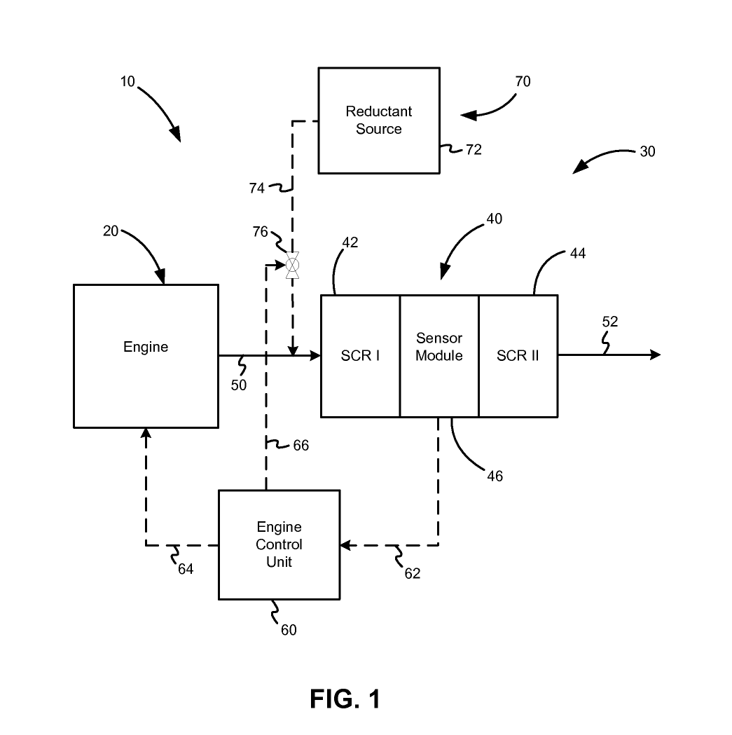

FIG. 1 depicts one embodiment of an internal combustion engine system 10. The main components of the engine system 10 include an internal combustion engine 20 and an exhaust gas after-treatment system 30 coupled to the engine. The internal combustion engine 20 can be a compression ignited internal combustion engine, such as a diesel-powered engine. Within the internal combustion engine 20, the air from the atmosphere is combined with fuel to power the engine. Combustion of the fuel and air produces exhaust gas. At least a portion of the exhaust gas generated by the internal combustion engine 20 is operatively vented to the exhaust gas after-treatment system 30 as indicated by directional arrow 50.

Generally, the exhaust gas after-treatment system 30 is configured to remove various chemical compound and particulate emissions present in the exhaust gas received from the engine 20. The exhaust gas after-treatment system 30 can include any of various exhaust treatment devices, such as diesel oxidation catalysts, diesel particulate filters, and SCR systems. Although the exhaust gas after-treatment system 30 may include one or more other devices or systems, in the illustrated embodiment, only an SCR system 40 is shown. In exhaust flow direction 50, exhaust flows from the engine 20 and through the SCR system 40 before exiting the SCR system as indicated by directional arrow 52.

The SCR system 40 includes an SCR catalyst device with a first SCR catalyst bed, substrate, or brick 42 upstream of a second SCR catalyst bed, substrate, or brick 44. In other words, the SCR system 40 includes an upstream SCR catalyst bed 42 and a downstream SCR catalyst bed 44.

The SCR system 40 further includes a sensor module 46 positioned between the upstream and downstream SCR catalyst beds 42, 44. The sensor module 46 receives exhaust gas from the upstream SCR catalyst bed 42 and senses a component (e.g., species) concentration in the exhaust gas before the exhaust gas flows into the downstream catalyst bed 44. In certain implementations, the SCR system 40 includes a single housing that housing the upstream SCR catalyst bed 42, downstream SCR catalyst bed 44, and sensor module 46. The component concentration reading or measurement is communicated over a communication line 62 to an engine control unit 60 that calculates a component concentration of the entire exhaust gas flow using an averaging technique based on the component concentration reading. In certain implementations, the engine control unit 60 is a separate exhaust after-treatment or SCR system control module which is electrically coupled to an engine control module.

The exhaust gas after-treatment system 30 can also include a reductant delivery system 70 which is located upstream of the upstream SCR catalyst bed 42. The reductant delivery system 70 includes a reductant source 72, a flow line connecting the reductant source to the exhaust gas stream as represented by directional arrow 50, and a control valve 76 which is operable to inject a dose of the reductant into the exhaust gas prior to the gas entering the SCR catalyst beds 42, 44. The injected reductant (or broken-down byproducts of the reductant, such as when urea is reduced to form ammonia) reacts with NOₓ in the presence of the SCR catalyst to reduce NOₓ in the exhaust gas to less harmful emissions, such as N₂ and H₂O. The SCR catalyst beds 42, 44 can be any of various catalysts known in the art. For example, in some implementations, the SCR catalyst beds 42, 44 each is a vanadium-based catalyst, and in other implementations, the SCR catalyst beds each is a zeolite-based catalyst, such as a Cu-Zeolite or a Fe-Zeolite catalyst.

In order to achieve a desired NOₓ reduction efficiency, fuel efficiency, and ammonia slip reduction, the calculated component concentration is used to control the operating conditions of the engine 20 via a communication line 64 and/or dosing of the reductant via a communication line 66 to the control valve 76 of the reductant delivery system 70. For example, in some implementations the calculated component concentration is used to generate a reductant dosing rate command from one or more predetermined maps. Alternatively, or additionally, the calculated component concentration can be used to detect failure of the SCR catalyst bed 42 and/or provide feedback correction of a dosing rate command. In such a mid-bed correction configuration, the sensor module 46 can effectively replace both a traditional sensor placed upstream of the SCR catalyst for reductant dosing rate determination purposes and a traditional sensor placed downstream of the SCR catalyst for on-board diagnostics (OBD) and correction purposes.

The spatial distribution of reductant and NOₓ at the inlet of the upstream SCR catalyst bed 42 affects the efficiency of the reduction of NOₓ by the upstream and downstream SCR catalyst beds 42, 44. Moreover, the distribution of reductant and NOₓ can be highly non-uniform and can vary significantly over an engine operating period. Non-uniformity of the spatial distribution of reductant and NOₓ at the inlet of the SCR catalyst bed 42 often translates into non-uniformity of the spatial distribution of reductant and NOₓ at the outlet of the SCR catalyst bed 42 and at the sampling location of the sensor module 46. Such spatial distribution non-uniformity typically is exhibited throughout the SCR system 40, including at the inlet and outlet of the second SCR catalyst bed 44. Because of the possibility of non-uniform reductant and NOₓ spatial distribution between the first and second SCR catalyst beds 42, 44, the sensor module 46 is configured to capture a sample of the exhaust gas exiting the first SCR catalyst bed that more accurately represents the component characteristics of the entire exhaust gas compared to conventional probe-type sensors. In this manner, the sensor module 46 promotes accurate control of the reductant dosing system, efficient reduction of NOₓ by the SCR system 40, an increase in fuel efficiency, and a decrease in ammonia slip.

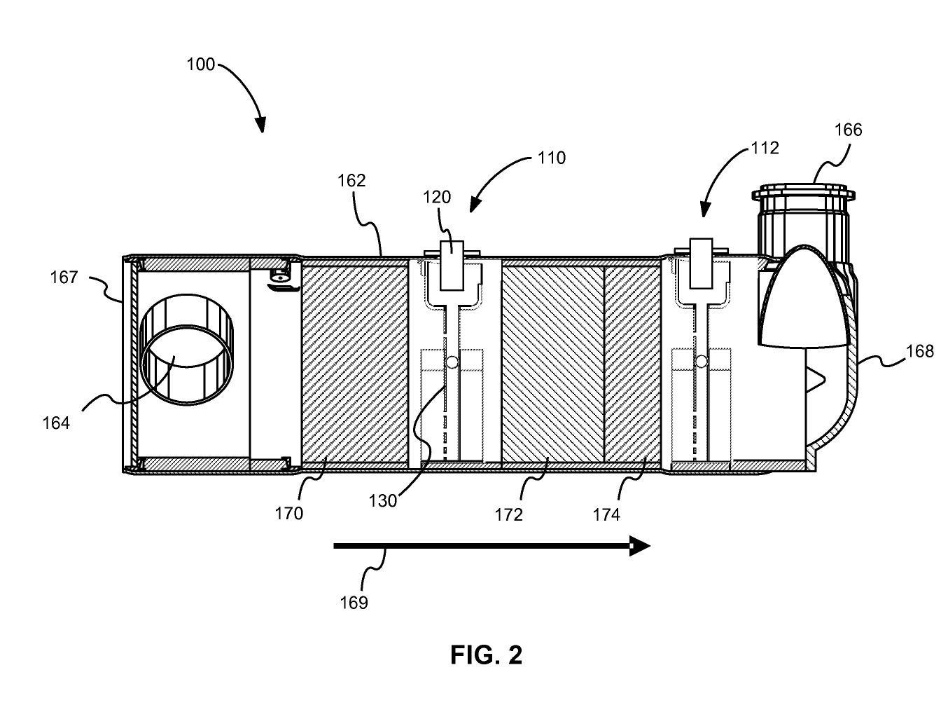

In accordance with another representative embodiment of the exhaust after-treatment system 100 illustrated in FIG. 2, a sensor module 110 similar to the sensor module 46 described above is utilized to sense the characteristics of exhaust flowing through the system. The exhaust after-treatment system 100 is an SCR system that includes a housing 162 within which an upstream SCR catalyst bed 170, a downstream SCR catalyst bed 172, and an ammonia oxidation (AMOX) catalyst bed 174 are housed. The housing 162 is substantially cylindrically shaped with an exhaust inlet 164 and an exhaust outlet 166. In operation, exhaust gas enters the housing through the inlet 164, flows from an upstream end 167 of the housing to a downstream end 168 in an exhaust gas flow direction 169, and exits the housing through the outlet 166. As the exhaust gas flows through the housing, the entirety of the exhaust gas stream flows through the upstream SCR catalyst bed 170, the downstream SCR catalyst bed 172, and the ammonia oxidation (AMOX) catalyst bed 174. Each of the catalyst beds 170, 172, 174 performs a specific emissions reduction operation on the exhaust gas as it passes through the beds.

The upstream and downstream catalyst beds 170, 172 define first and second portions or bricks (e.g., separate halves) of an SCR catalyst. Traditionally, the housing of an SCR system of an individual exhaust line houses a single SCR catalyst with a monolithic, one-piece catalyst bed. In the illustrated embodiment, however, the traditional SCR catalyst has been divided into two separate and spaced-apart portions (i.e., the upstream and downstream SCR catalyst beds 170, 172). The AMOX catalyst 174 in the illustrated embodiment is coupled to (e.g., integrated with) the downstream SCR catalyst bed 172. However, in certain other embodiments, the after-treatment system 100 does not have an AMOX catalyst, or has an AMOX catalyst that is separate from the downstream SCR catalyst bed 172. In one specific implementation as an example, the upstream and downstream SCR catalyst beds 170, 172 each have an approximately 13-inch diameter and 6-inch axial length. If present, the AMOX catalyst 174 can have an approximately 13-inch diameter and 3-inch axial length. Of course, in other implementations, the SCR catalyst beds 170, 172 and AMOX catalyst 174 can have any of various other sizes and shapes.

The space defined within the housing 162 between the upstream and downstream SCR catalyst beds 170, 172 is occupied by the sensor module 110, which includes both a sensor 120 and a sample probe 130. The sensor module 110 can be coupled to the housing 162 using any of various techniques. In the illustrated embodiment, the sample probe 130 of the sensor module 110 is secured to an interior surface of the housing 162 using a coupling technique, such as one or more of an adhering, a fastening, or a welding technique, while the sensor 120 can inserted through the housing 162 until a sensing tip of the sensor is correctly positioned with an appropriate sampling region.

Similar to the operation of sensor module 46 described above, sensor module 110 entrains a sample portion of the exhaust gas stream flowing from the outlet of the first SCR catalyst bed 170 and senses characteristics of the entrained gas before reintroducing the sample portion back into the exhaust gas stream. The sensed characteristics are reported to an engine control unit or reductant dosing controller (not shown) for precise and accurate control of the reductant dosing characteristics of the SCR system 100. In this manner, the sensor module 110 provides mid-bed reductant dosing control and/or correction capabilities without the need for an upstream static mixer and mixing tube to mix and evenly distribute the exhaust gas prior to sensing the exhaust gas.

Optionally, the SCR system 100 includes a second sensor module 112 similar to the first sensor module 110, but positioned downstream of the second SCR catalyst bed 172. For example, the SCR system 100 includes a second space defined within the housing 162 between the downstream SCR catalyst bed 172 and the downstream end 168 of the housing. The second sensor module 112 can be positioned within this second space, but alternatively may also be rotated ninety degrees and positioned in a suitable location within the SCR system's exhaust outlet 166 or within the exhaust piping that is further downstream from the exhaust outlet 166.

Like the first sensor module 110, the second sensor module 112 entrains a sample portion of the exhaust gas stream flowing from the outlet of the second SCR catalyst bed 172 or AMOX catalyst bed 174, and senses characteristics of the entrained portion. The sensed characteristics are reported to an engine control unit, or exhaust after-treatment controller, for controlling operation of the exhaust after-treatment system. In one embodiment, the first sensor module 110 is configured to measure a concentration of ammonia in the exhaust gas exiting the first SCR catalyst bed 170. More specifically, the sensor of the first sensor module 110 is an ammonia concentration sensor. The second sensor module 112 can be configured to measure a concentration of NOₓ in the exhaust gas exiting the second SCR catalyst bed 172. More specifically, the sensor of the second sensor module 112 is a NOₓ concentration sensor.

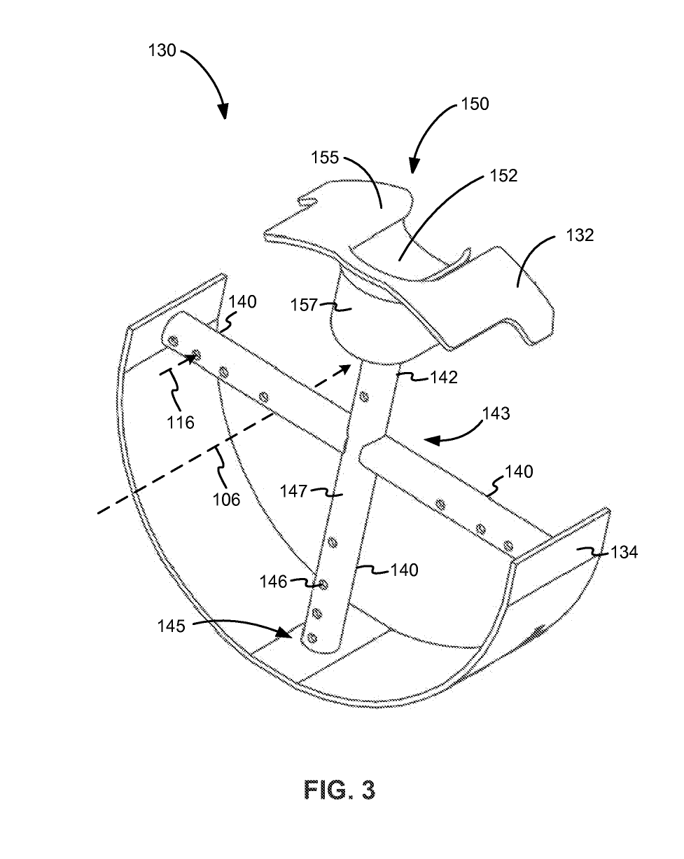

The sample probe 130 of the sensor module 110 is illustrated with more detail in FIG. 3. As can be seen, the sample probe 130 includes at least two sample arms 140, 142 which are coupled together at a central portion 143 and extend radially outward from the central portion to an outward end 145 which is coupled to either an upper fairing 132 or a lower fairing 134, which can be arcuate shaped. The upper fairing 132 and lower fairing 134 in turn are attached to the interior surface of the housing 160 of FIG. 2 which defines the fluid conduit into which the sample probe 130 is installed. In the illustrated embodiment, the upper and lower fairings 132, 134 are non-continuous, or separate and disconnected components.

Each sample arm is defined as either a single flow sample arm 140 or an aggregate flow sample arm 142. Generally, sample portions of the captured fluid entering the single flow sample arms 140 flow into and combine with sample portions entering and flowing through the aggregate flow sample arm 142. The sample probe 130 illustrated in FIG. 3 includes one aggregate flow sample arm 142 and three single flow sample arms 140, with the four arms being equally angularly-spaced apart from each other. However, in other embodiments, the sample probe can include fewer or more than four arms, with the arms being equally angularly-spaced apart from each other or with different angular intervals between the arms.

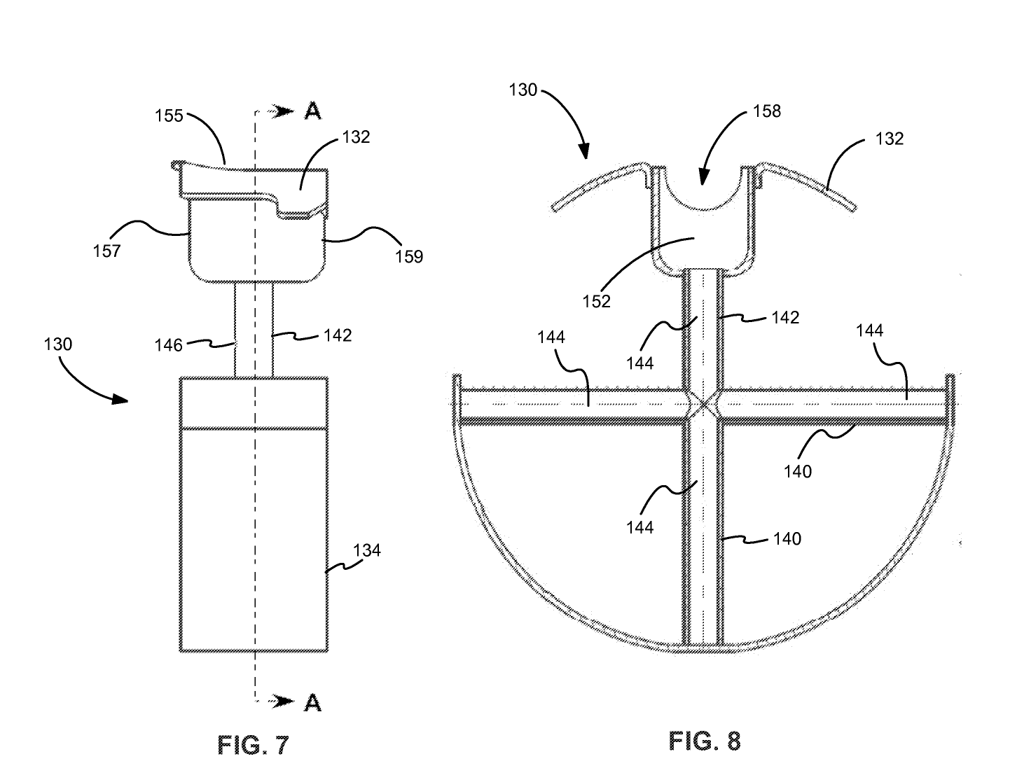

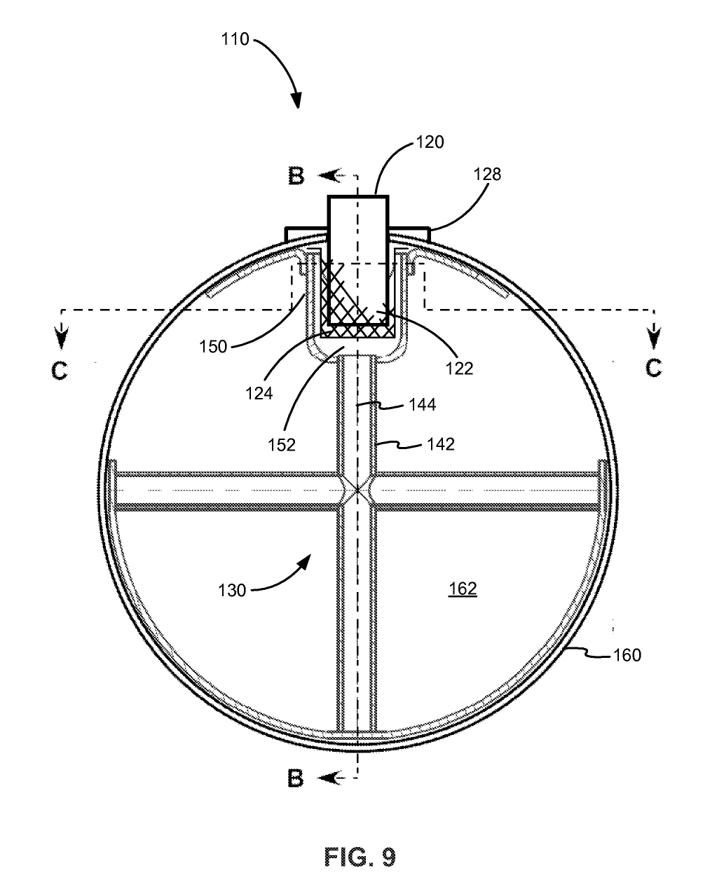

The sample arms 140, 142 are hollow and each include a fluid flow channel 144 formed therein (see FIGS. 7, 9). The fluid flow channel 144 of each sample arm can have any of various cross-sectional shapes, such as, for example, circular, elliptical, triangular, polygonal, and the like. The sample arms 140, 142 each include a set of inlet apertures 146 through which a sample portion 116 of a main fluid flow 106 is captured and directed into the fluid flow channels of the sample arms. As shown in FIG. 3, the inlet apertures 146 can be formed in respective upstream facing surfaces 147 of the sample arms 140, 142 such that each of the inlet apertures faces an upstream direction (i.e., normal to a fluid flow direction). In other words, the central axes of the inlet apertures 146 are substantially parallel to the fluid flow direction. In alternative embodiments, however, the inlet apertures 146 can also be angled into the side (or top and bottom) surfaces of the sample arms as well as in other non-normal locations/orientations as may be deemed appropriate. For example, in such alternative embodiments, the apertures 146 face directions angled with respect to the fluid flow direction. In other words, the central axes of the angled inlet apertures are substantially non-parallel to the fluid flow direction.

Further, the inlet apertures 146 of a respective sample arm 140, 142 are radially aligned along the respective arm from a location proximate a center portion of the sample arm to a location near or proximate the radially outward end 145 of the sample arm. In the illustrated embodiment, each single flow sample arm 140 includes four inlet apertures 146 while the aggregate flow sample arm 142 includes a single inlet aperture. However, in other embodiments, each sample arm may include fewer or more inlet apertures. As shown, the inlet apertures 146 are substantially circular-shaped. However, in other embodiment, the inlet apertures 146 can have other shapes, such as polygonal, elliptical, rectangular, triangular, and the like.

The sample probe 130 further includes a sensor well 150 that is located at the outward end 145 of the aggregate flow sample arm 142. The sensor well 150 is a blunt, rounded body that encloses an interior volume 152 in fluid communication with the fluid flow channel 144 formed into the aggregate flow sample arm 142. The sensor well 150 includes an outer portion 155, which opens to an interior surface of the fluid conduit or housing into which the sample probe is installed, with the upper fairing 132 providing a contact interface with the interior surface of the fluid conduit at both the upstream end and to either side of the sensor well to help secure the sample probe within the fluid conduit. Also shown in FIG. 3, the sensor well 150 includes a front portion 157 having a blunt, rounded surface for diverting the fluid flowing through the fluid conduit around the sensor well.

The sample probe 130 is installed within the fluid conduit or housing such that the conduit or housing extends completely around the sample probe 130 and causes the fluid flowing through the conduit to either pass between the sample arms 140, 142 as the main fluid flow 106, or into the inlet apertures 146 and through the interior passages of the sample probe 130 as the sample portion 116 of the fluid flow.

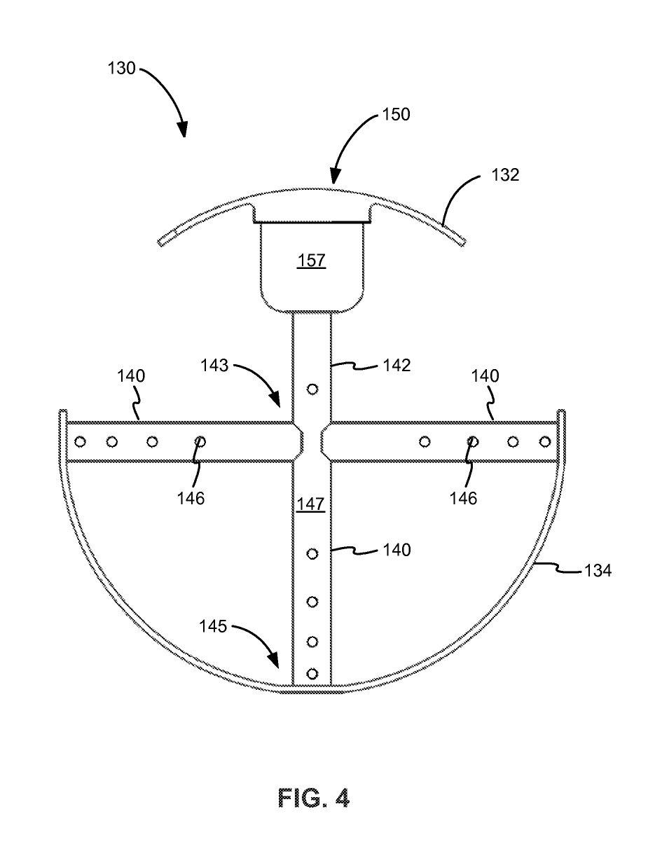

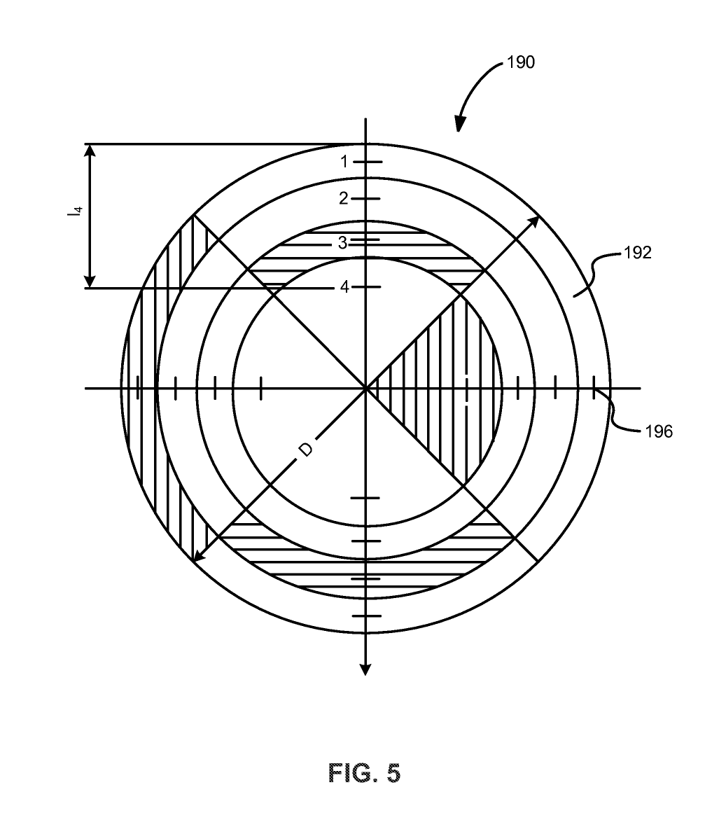

A front view of the sample probe 130 is provided in FIG. 4, which shows that the inlet apertures 146 of the single flow sample arms 140 and the aggregate flow sample arm 142 are equally sized with each other, but are spaced closer together near the outer ends 145 of the single flow sample arms 140. This is because the sample probe 130 is configured to take a sample of the main fluid flow having characteristics (e.g., species concentrations) that accurately represent the characteristics of the main fluid flow. Accordingly, the sample probe 130 accounts for the possibility of non-uniform fluid distribution patterns (i.e., non-uniform species mass fraction distribution) across a cross-section of a fluid stream flowing through a conduit by taking multiple samples of the fluid along multiple radially-spaced annular segments of the fluid stream, in accordance with the equal area sampling methodology 190 illustrated in FIG. 5.

As shown in the diagram of FIG. 5, one technique for equal area sampling 190 is facilitated by dividing the cross-section of the main fluid flow in the fluid conduit into N (e.g. 16) arc-shaped sections (e.g. arc sections) 192 of equal area. Equal area sampling is achieved by positioning each inlet aperture 146 at a location on the sample arm 140 which corresponds with a point 196 within a respective arc section 192. For example, the embodiment of FIGS. 4 and 5 uses a tangential method wherein the sample points within the arc sections are associated with a midpoint of the arc sections. In other embodiments using different methods, such as a log-linear or a log-chebyshev method, the points within the annular sections may be associated with a center of a pre-defined fluid velocity distribution within the annular sections.

The distance lⱼ of the inlet apertures 146 from the interior surfaces of the fluid conduit may be scaled in accordance with a parametric relationship which depends upon the diameter “D” of the fluid conduit and the number “n” of inlet apertures 146 in each single flow sample arm 140. For precise calculations, the following equation can be used:

$$lj = \frac{D}{2} ( 1 - \sqrt{\frac{2 n - 2 j + 1}{2 n}} )$$

For calculations requiring a lower level of resolution, the following relationship can be used, with k₁ to k₄ equal to 3.3, 10.5, 19.4 and 32.3, respectively, when the number of inlet apertures 146 in each sample arm is four.

$$lj = kj ( \frac{D}{100} )$$

Because the areas of the arc sections are the same, the radial width of each arc section decreases in the radially outward direction. Accordingly, the distance between adjacent apertures correspondingly decreases in the radially outward direction. As shown in FIG. 4, for example, sample probe 130 has three single flow sample arms 140, each with four variably-spaced and equally-sized inlet apertures 146. The distances between the inlet apertures 146 of the single flow sample arms 140 increase in a radially inward direction. In other words, the apertures 146 are closer to each other at the radially outward portion 145 of the arms 140 than the center portion 143 portion of the arms. The aggregate flow sample arm 142 may include only a single inlet aperture corresponding to a center arc section, with the remaining three sample points in the pattern being omitted to provide spacing for the sensor well 150 at the outward portion 145 of the aggregate flow sample arm 142. It has been found, nevertheless, that the illustrated configuration of the inlet apertures 146 in the sampling probe 130 is substantially accurate in capturing any non-uniform mass fraction distributions which may exist across the cross-section of the fluid stream passing through the fluid conduit. Furthermore, the size and number of inlet apertures 146 can be selected to produce a sampled volumetric flow rate which is 1% to 4% of the total volumetric flow rate flowing through the fluid conduit.

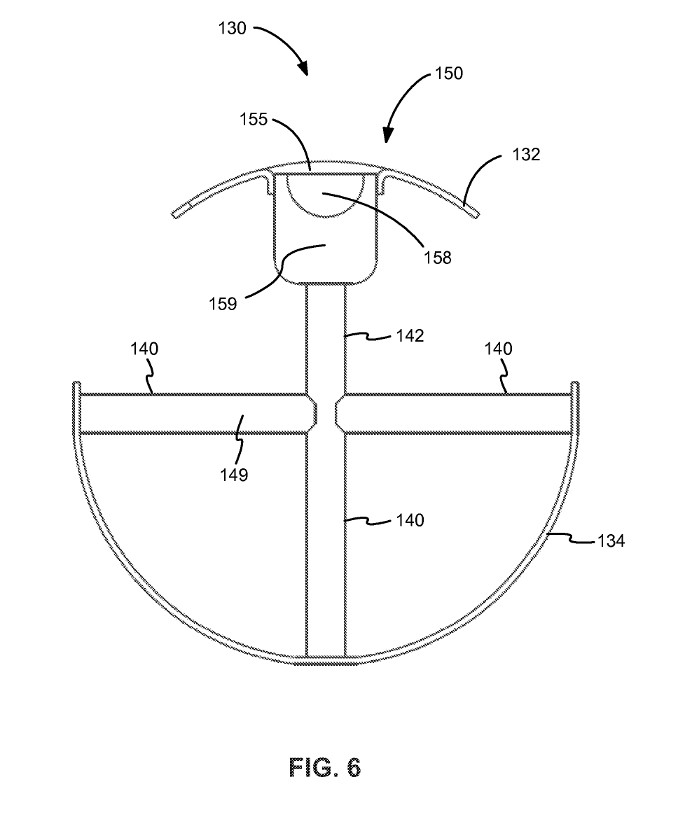

A rear view of the sample probe 130 showing the downstream surfaces 149 of the sample arms 140, 142 and the back portion 159 of the sensor well 150 is provided in FIG. 6. The back portion 159 includes a discharge aperture 158 which allows the captured sample portion of the flow to exit the interior volume of the sensor well and return to the main flow. As shown, the discharge aperture may have a substantially semi-circular cross-sectional shape, which facilitates a desired flow pattern of exhaust gas exiting the sensor well.

FIGS. 7 and 8 provide a side and cross-sectional front view of the isolated sample probe 130, respectively. As can be seen, each of the sample arms 140, 142 includes a fluid flow channel 144 which directs the captured sample portion of fluid towards the sensor well 150, where it then exits the sample probe 130 through the discharge aperture 158.

The cross-sectional front view of FIG. 8 is repeated in FIG. 9, but with the sample probe 130 being installed together with the sensor 120 within the fluid conduit or housing 160 of the SCR system to form the sensor module 110. The sensor 120 is installed through the wall of the fluid conduit 160 and positioned deep within the sensor well 150 so that a sensing tip 122 is located proximate the opening 148 between the aggregate flow sample arm 142 and the interior volume 152 of the sensor well 150.

The sensor 120 can be secured in place against the outside surface of the fluid conduit with a sensor receptacle 128. In the embodiment shown, the sensor 120 or sensor receptacle 128 can also include a condensing screen or basket 124 which may envelope the sensor 120 to protect the sensor from moisture and corrosive liquids. The spacing of the holes in the screen are small enough to prevent any moisture droplets from passing through the screen to contact the sensing tip 122 of the sensor 120, but still large enough to allow gases and vapors to come into contact with the sensing element.

Also shown in FIG. 9, the fluid flow channels 144 of each sample arm 140, 142 can have any of various hydraulic diameters. In some embodiments, the channels 144 have a hydraulic diameter between about 0.25 inches and 2 inches (e.g., between about 0.25 inches and 0.75 inches in some implementations). In one specific implementation, and as one example, the sample arms 140, 142 each define an approximately one-inch hydraulic diameter fluid flow channel 144 and the inlet apertures 146 formed in the sample arms each has an approximately 4.75 mm diameter. Because the size of the sample arms 140, 142 is relatively small compared to the size of the fluid channel 162 formed by the housing 160 of the SCR system, the sample probe 130 is minimally intrusive or obstructive (i.e., reduces the effect of the sensor module on the spatial distribution of fluid flow velocity and species).

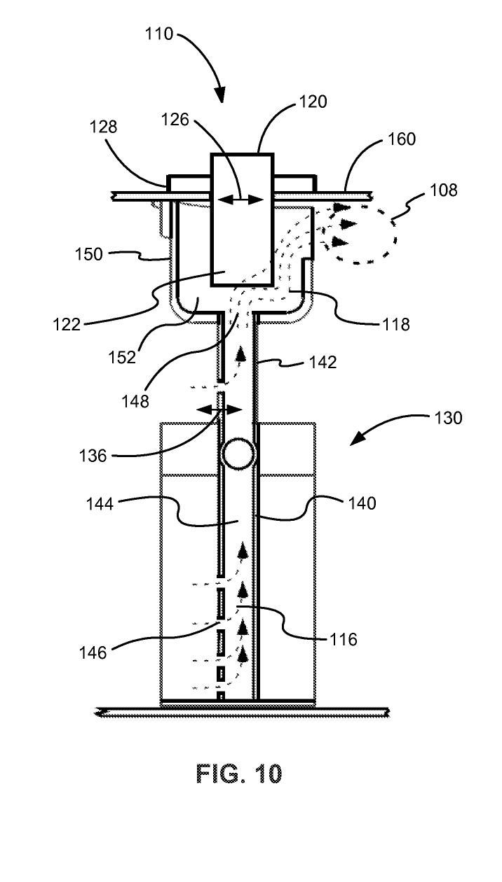

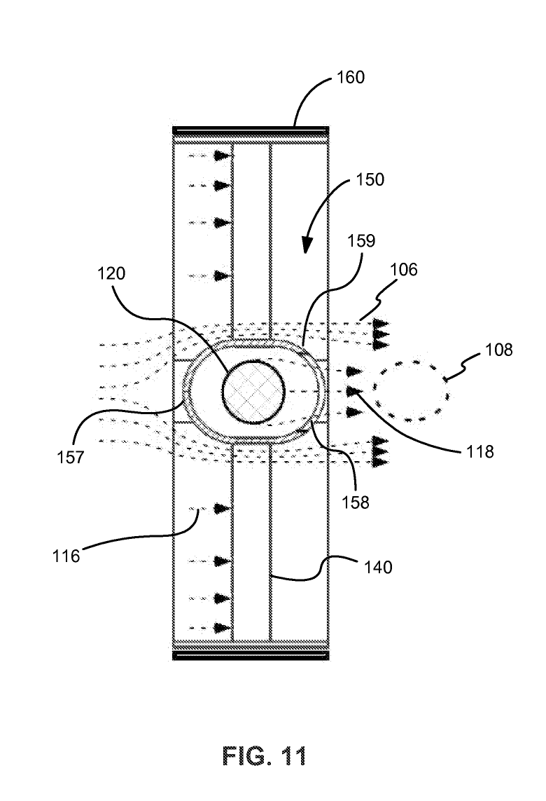

The flowpaths of the various fluid flows through sample probe 130 and around the sensing tip 122 of the sensor 120 are illustrated in FIGS. 10 and 11, which are cross-sectional views of the sample probe 130 and sensor well 150, respectively. Referring first to FIG. 10, the sample portions 116 of the main fluid flow passing through the fluid conduit 160 enter the sample probe 130 through the inlet apertures 146 formed in the sample arms 140, 142. The sample portions 116 pass into the fluid flow channels 144 inside the sample arms, where they are combined and directed towards sensor well 150, entering the internal volume 152 of the sensor well through opening 148 as an averaged combined sample flow 118 containing a representative mix of all the constituents of the exhaust gas currently passing around and between the sample arms of the sample probe 130. The combined sample flow 118 is then drawn across and around the sensing tip 122 of the sensor 120 which takes measurements of the combined sample flow 118 within the internal volume 152. The combined sample flow 118 then makes its way towards the discharge aperture 158 where it is drawn back out of sample probe 130 to recombine with the main fluid flow.

The axial position 136 of the sample arms 140, 142 relative to the axial position 126 of the sensor tip 122 can be adjusted so that most of the averaged combined sample flow 118 turns after entering the sensor well 150 through opening 148 and passes parallel to the bottom face of the sensor tip 122 rather than impacting directly against the bottom face. In making this adjustment, either the axial location 136 of the sample arms 140, 142 relative to the sensor well 150 or the axial location 126 of the sensor 120 relative to the sensor well 150 can be moved. In one aspect, for instance, the forward-facing surfaces of the sample arms 140, 142 can be made flush with the forward-facing surface of the sensor well 150, so that the averaged combined sample flow 118 enters the interior volume 152 through opening 148 at the 3 o'clock position near the front portion of the sensor well and exits at the 9 o'clock position through the discharge aperture in the back-facing surface of the sensor well.

A passive negative pressure inducing feature for enhancing the flow of the sample portions 116 through the sample probe 130 is illustrated in FIG. 11. For example, in addition to providing a protected internal volume 152 for sensing the combined sample flow 118, the sensor well 150 also provides a front portion 157 having a blunt rounded front surface which diverts and redirects the main fluid flow 106 passing around the sensor well. The sensor well 150 further provides a back portion 159 having the discharge aperture 158 formed therein, and which further can have a shape which encourages the main fluid flow to separate from the back portion 159 of the sensor well 150 when the main fluid flow 106 reaches a minimum speed. The separation of the main fluid flow 106 from the back portion 159 of the sensor well 150 causes a low pressure region 108 to form adjacent the sensor well and proximate the discharge aperture 158, which in turn operates to draw the combined sample flow 118 out from the internal volume 152 of the sensor well. This same low pressure region 108 can be seen proximate the discharge aperture 158 in FIG. 10.

Although the discharge aperture 158 is located in the rear surface of the back portion 159 and the low pressure region 108 is shown immediately behind the sensor well 150 in FIGS. 10 and 11, it is to be appreciated that other locations for the one or more discharge apertures and other shapes for the sensor well are also possible for creating the passive negative pressure inducing feature which draws the sample portion through the sample probe, and these variations should be considered to fall within the scope of the present invention. For instance, the discharge apertures could be located in the side surfaces of the back portion of the sensor well, and in fluid communication with low pressure regions formed in the fluid as it speeds around the side surfaces of the sensor well. Modifications could also be made to the cross-sectional shape of the sensor well (as seen in FIG. 11) that would alter the position of the low pressure region, with a corresponding adjustment to the location of the discharge apertures to place the discharge apertures into alignment with the lower pressure regions to create the passive negative pressure inducing feature.

Although the blunt body of the sensor well 150 is configured to divert and redirect the portion of the main fluid flow 106 that is passing near to the sensor well, the sensor well is also strategically located near the wall of the fluid conduit 160 where the fluid velocity is less than the fluid velocity proximate the center of the fluid conduit. This allows the sensor well 150 to induce the low pressure/negative pressure aspects of the sensor module without simultaneously introducing a substantial obstruction into the main fluid flow that would otherwise create a detrimental increase in back pressure which could choke the engine, especially in situations where the sensor module is scaled to differently-sized fluid systems.

The blunt body of the sensor well 150 in combination with the placement of the discharge aperture 158 is a passive negative pressure inducing feature. Other passive negative pressure inducing features can be used, such as restriction devices and venturi-aspirator type arrangements. Alternatively, or additionally, the negative pressure inducing feature can be an active feature, such as a pump. In certain implementations, such as for applications having a convergent outlet pipe section downstream of a fluid treatment device, the sensor module 110 includes an extension line from the sensor well to an inlet of the outlet pipe section instead of a pressure inducing feature. Such implementations take advantage of the low pressure conditions developed at the inlet of a convergent pipe section to create the positive pressure differential.

The sensor module 110 associated with FIGS. 9-11 can be defined as a non-bypass sensor module. More specifically, because the sample probe 130 of the sensor module 110 releases the sampled portion of fluid (e.g., sample flow 118) into the approximately same space as the sample probe, the sensor modules are non-bypass sensor modules. For example, referring back to the SCR system embodiment shown in FIG. 2, both the inlet apertures and discharge aperture of the sample probe 130 are located within a space defined between two SCR catalyst beds 170, 172.

In many cases the non-bypass sensor modules 110 are able to draw sample portions 116 of the fluid flowing through the fluid conduit 160 into the sample probe 130 by virtue of a negative pressure inducing element, such as a blunt shape of the sensor well 150 (FIG. 10). However, in some instances, the use of a negative pressure inducing element may not be desirable or feasible depending on the particular application. For example, some particular types of negative pressure inducing elements may negatively alter the pattern of fluid flowing into a downstream treatment device. Accordingly, in some embodiments, a bypass sensor module can be used.

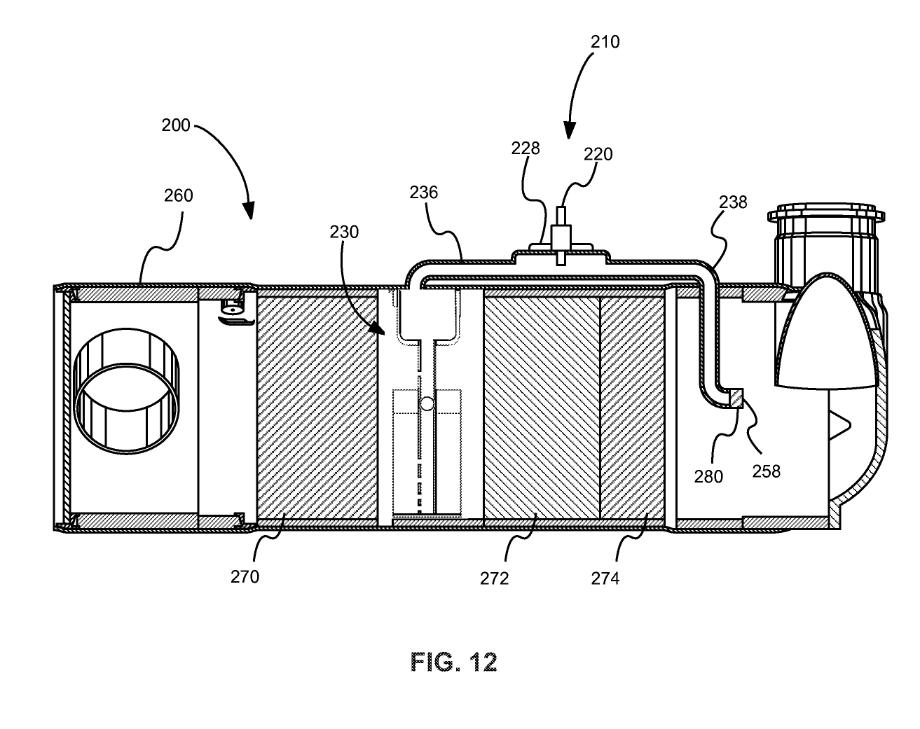

Referring to FIG. 12, a bypass sensor module 210 according to one embodiment is utilized in an SCR system 200 similar to the SCR system 100 of FIG. 2. The sensor module 210 includes a sample probe 230 having sample arms and inlet apertures configured in the same or similar manner as the sample probe described above, so as to capture a representative mix of all the constituents of the exhaust gas currently passing around and between the sample arms of the sample probe 230. However, the sample probe 230 does not provide a near immediate return of sampled fluid from the sample probe to the fluid passing through the fluid conduit. Rather, a fluid sampling line 236 extends away from the sample probe 230 to bypass a downstream fluid treatment device (e.g., the second SCR catalyst bed 272) and place the discharge aperture 258 from the sensor well at the end of a fluid outlet line 238 located downstream of the downstream fluid treatment device. Such a configuration utilizes the inherent positive pressure differential created across the downstream fluid treatment device to draw sample portions of fluid into the sample probe 230. In this manner, a passive or active negative pressure inducing feature is not required at the discharge aperture of the sensor well. Therefore, the potential for negatively affecting the fluid flow pattern that may be associated with a negative pressure inducing feature is reduced when using a bypass sensor module such as sensor module 210.

In some embodiments, the sensor module 210 includes a restriction device 280 at discharge aperture 258 to adjust (e.g., optimize) the pressure differential by restricting or blocking a portion of the exhaust flowing through the outlet line 238. The restriction device can be any of various restriction devices, such as, for example, orifice plates, perforated plates, and the like.

The fluid sampling line (i.e., bypass line) of a bypass sensor module can be configured in various ways depending on the application. As illustrated, the fluid sampling line 236 extends out of the housing 260 upstream of the downstream SCR catalyst bed 272 and runs adjacent an outer surface of the housing in an exhaust flow direction. From the fluid sampling line 236, the fluid outlet line 238 extends back into the housing downstream of the downstream SCR catalyst bed 272 and AMOX catalyst bed 274. As illustrated, the fluid outlet line 238 extends into the exhaust stream such that the discharge aperture 258 of the fluid outlet line 238 expels exhaust into a central portion of the main exhaust stream generally in the exhaust flow direction. In other embodiments, however, the fluid outlet line 238 can terminate at the housing wall such that the discharge aperture 258 of the fluid outlet line is formed in the wall to expel exhaust into a radially outward portion of the main exhaust stream. In another implementation, a small portion of the fluid outlet line 238 can extend into the main exhaust stream to form a downstream angled outlet proximate the housing wall. Other configurations for locating the discharge aperture 258 of the sample probe 230 downstream of the downstream catalyst beds 272, 274 are also possible, and are considered to fall within the scope of the present invention.

The sensor receptacle 228 and sensor 220 are located on the fluid sampling line 236 at some location between the sample probe 230 and fluid outlet line 236. Because the fluid pressure downstream of the downstream SCR catalyst bed 272 is lower than the fluid pressure upstream of the downstream SCR catalyst bed, a representative portion of the main exhaust stream is drawn into the sample probe 230, along the fluid sampling line 236, and into the fluid outlet line 238. In alternative embodiments, the fluid sampling line 236 does not extend outside of the housing 260, but extends through the downstream SCR catalyst bed 272 and AMOX catalyst bed 274.

Although the sensors of the several specific implementations for exhaust treatment applications described above have been categorized as one of ammonia and NOₓ sensors, in other implementations, the sensors can be other types of sensors, such as, for example, hydrocarbon sensors, carbon monoxide sensors, and the like. Alternatively, in applications outside of exhaust treatment, the sensors can be any of various sensors for sensing any of various fluid flow characteristics as desired. Furthermore, the sensors described herein can be placed at any of various locations within an exhaust aftertreatment system to sense the any of various characteristics or components (e.g., mass concentrations of constituents within the exhaust gas stream).

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A sensor module for sensing characteristics of a fluid flowing through a fluid conduit, comprising:
a sample probe at least partially positioned within the fluid conduit, the sample probe comprising:
at least one sample arm extending radially inwardly from a sidewall portion of the fluid conduit to a center portion of the fluid conduit, the at least one sample arm defining a fluid flow channel and comprising a plurality of inlet apertures open to the fluid flow channel and the fluid conduit; and
a sensor well located at a radially outer end of the at least one sample arm, the sensor well defining an interior volume in fluid communication with the fluid flow channel, the sensor well comprising an upstream portion closed to a first portion of the fluid conduit upstream of sensor well and a discharge aperture open to a second portion of the fluid conduit downstream of the sensor well; and
a sensor positioned at least partially within the interior volume of the sensor well.

2. The sensor module of claim 1, wherein the plurality of inlet apertures captures a sample portion of fluid flowing through the fluid conduit and directs the sample portion of fluid into the interior volume of the sensor well, the sensor being in fluid communication with the sample portion of fluid in the interior volume.

3. The sensor module of claim 1, wherein the sensor is inserted through the fluid conduit.

4. The sensor module of claim 1, wherein the sensor well further comprises a downstream portion configured to create a low pressure zone in the fluid conduit adjacent the discharge aperture.

5. The sensor module of claim 4, wherein the low pressure zone draws the sample portion through the plurality of inlet apertures, through the fluid flow channel, through the interior volume of the sensor well, and into the low pressure zone via the discharge aperture.

6. The sensor module of claim 1, wherein the sensor well has a substantially ovular cross-sectional shape.

7. The sensor module of claim 1, wherein a volume per unit length of the fluid flow channel is smaller than a volume per unit length of the interior volume of the sensor well.

8. The sensor module of claim 1, wherein the sample probe comprises a plurality of sample arms each extending radially inwardly from the sidewall portion of the fluid conduit to the center portion of the fluid conduit, each of the sample arms defining a fluid flow channel, wherein the fluid flow channels of the plurality of sample arms are fluidly coupled at the center portion of the fluid conduit, and wherein the sensor well is located at the radially outer end of one of the plurality of sample arms.

9. The sensor module of claim 1, wherein the sensor well comprises a blunt body.

10. The sensor module of claim 1, wherein the sensor well is shaped to induce a pressure differential between the plurality of inlet apertures and the discharge aperture.

11. The sensor module of claim 1, wherein the plurality of inlet apertures are spaced closer together near the sidewall portion of the fluid conduit than near the center portion of the fluid conduit.

12. The sensor module of claim 11, wherein for each inlet aperture j of the plurality of inlet apertures, the radial distance l away from the sidewall portion of the fluid conduit is equal to
$$\frac{D}{2} ( 1 - \sqrt{\frac{2 n - 2 j + 1}{2 n}} )$$
where D is the diameter of the fluid conduit and n is the number of inlet apertures.

13. The sensor module of claim 1, further comprising a screen positioned within the interior volume of the sensor well, wherein the screen envelopes the sensor.

14. The sensor module of claim 1, wherein the discharge aperture has a semi-circular cross-sectional shape.

15. An exhaust aftertreatment system, comprising:
an exhaust conduit through which an exhaust gas is flowable;
at least one sample probe positioned within the exhaust conduit, the at least one sample probe comprising at least two sample arms coupled together at a central location and extending radially outwardly away from the central location, wherein each of the at least two sample arms defines an exhaust flow channel formed therein, and each of the at least two sample arms comprising a plurality of inlet apertures extending from an upstream surface of the sample arm to the exhaust flow channel for capturing a sample portion of exhaust gas flowing through the exhaust conduit, the at least one sample probe further comprising a sensor well located at a radially outward end of one of the at least two sample arms, the sensor well defining an interior volume in exhaust receiving communication with the exhaust flow channels of the at least two sample arms, wherein the sensor well comprises an upstream portion having a blunt rounded surface for diverting exhaust gas flowing through the exhaust conduit around the sensor well, an exhaust discharge aperture open to the exhaust conduit, and a downstream portion for creating a low pressure zone in exhaust gas flowing through the fluid conduit just downstream of the exhaust discharge aperture; and
a sensor positioned at least partially within the interior volume of the sensor well.

16. The exhaust aftertreatment system of claim 15, further comprising a first exhaust treatment device positioned within the exhaust conduit upstream of the at least one sample probe, and a second exhaust treatment device positioned within the exhaust conduit downstream of the at least one sample probe.

17. The exhaust aftertreatment system of claim 16, wherein the first exhaust treatment device comprises a first selective catalytic reduction (SCR) catalyst, and the second exhaust treatment device comprises a second SCR catalyst.

18. The exhaust aftertreatment system of claim 16, wherein the at least one sample probe is a first sample probe and the sensor is a first sensor, the exhaust aftertreatment system further comprising a second sample probe positioned within the exhaust conduit downstream of the second exhaust treatment device, wherein the exhaust aftertreatment system comprises a second sensor positioned at least partially within the interior volume of the sensor well of the second sample probe.

19. The exhaust aftertreatment system of claim 15, wherein the at least one sample probe comprises an upper arcuate fairing attached to the sensor well located at the radially outward end of the one of the at least two sample arms and a lower arcuate fairing attached to the other of the at least two sample arms, the upper and lower fairings being disconnected from each other, wherein the upper and lower fairings are attached to an interior surface of the exhaust conduit.

20. A method for sensing characteristics of a fluid flowing through a fluid conduit, comprising:
capturing portions of the fluid at a plurality of radial locations along a cross-section of the fluid conduit;
directing the captured portions of the fluid into a sensor well located at a radially outer portion of the fluid conduit;
passing the captured portions of the fluid across a sensor located in the sensor well;
creating a low pressure zone in the fluid flowing through the fluid conduit at the radially outer portion of the fluid conduit adjacent and downstream of the sensor well; and
drawing the captured fluid in the sensor well back into the fluid conduit through an aperture in the sensor well via a pressure differential created by the low pressure zone.
